(19) United States
(12) Patent Application Publication
(10) Pub. No.: US 2012/0131843 A1
(43) Pub. Date: May 31, 2012

(54) FISHING FLOAT METHOD AND APPARATUS

(76) Inventors: Roger Peak, Lafayette, LA (US); Fred Digiulio, Ajijic Jalisco (MX); Charles Lanusse, Opelousas, LA (US)

(21) Appl. No.: 13/307,638

(22) Filed: Nov. 30, 2011

Related U.S. Application Data
(60) Provisional application No. 61/417,928, filed on Nov. 30, 2010.

(51) Int. Cl. A01K 93/00

(52) U.S. Cl. 43/44.9

(57) ABSTRACT

A fishing float having a buoyant body member and a central slot extending along the length of the body member. A flexible clasp member is inserted within the central slot of the body member. A fishing line is inserted within the flexible clasp member, frictionally securing the fishing line within the slot. The fishing float can be easily and quickly attached to fishing line, or removed from the fishing line, without damaging or impairing the fishing line.

### CROSS REFERENCES TO RELATED APPLICATION

Priority of U.S. Provisional Patent Application Ser. No. 61/417,928, filed, Nov. 30, 2010, incorporated herein by reference, is hereby claimed.

### STATEMENTS AS TO THE RIGHTS TO THE INVENTION MADE UNDER FEDERALLY SPONSORED RESEARCH AND DEVELOPMENT

None

### BACKGROUND OF THE INVENTION

1. Field of the Invention

The present invention pertains to fishing floats—frequently referred to as a “bobbers” or “corks”—commonly used in connection with angling and related activities. More particularly, the present invention pertains to fishing floats that permit quick and easy attachment, removal, and/or re-attachment to a fishing line. More particularly still, the present invention pertains to fishing floats that prevent impairment of or damage to fishing line.

2. Brief Description of the Prior Art

Floats or bobbers are well known in the art. Generally, a bobber is a device used in angling to suspend bait at a predetermined water depth. Additionally, a bobber can also serve as a bite indicator. Although not absolutely required, bobbers are often used in conjunction with fishing weights or “sinkers”.

In most cases, bobbers are buoyant and are designed to float at or near the surface of a body of water. At least one hook, together with associated bait attached to said at least one hook, are typically suspended below a bobber. When a fish strikes at bait and bites a hook, the fish will typically pull the bobber fully or partially under water. This movement of the bobber can provide visual indication to a fisherman that that a fish has bitten the fisherman's bait.

Bobbers come in many different sizes and shapes. In most cases, bobbers embody predetermined shapes designed to best perform in particular environments and/or to suit particular styles of fishing activity. Bobbers are usually brightly colored so that they are easy to see, especially from a significant distance.

Existing bobber designs can be difficult to attach and remove from fishing line. Further, existing bobbers can damage fishing line, which can negatively impact the performance of such fishing line. Accordingly, there is a need for an improved fishing float that can be easily and conveniently attached to a fishing line and be removed from such line. Such improved fishing float should not damage or otherwise impair fishing line.

### SUMMARY OF THE PRESENT INVENTION

The fishing float of the present invention comprises a buoyant body member. Although said buoyant body member can have any number of different shapes or configurations to accommodate particular uses and/or environments to be encountered, in the preferred embodiment said body member has a substantially elongate shape having at least one tapered surface. A central bore extends axially through said body member. Similarly, a slot extends along the length of the body member, and extends from an outer surface of said body member to said central bore.

A flexible clasp member is received within the central bore and slot of said body member; said flexible clasp member can be axially inserted or pulled into said bore and slot of said body member. Said flexible clasp member further has an elongate mouth or opening that generally corresponds with the slot in said body member. A fishing line can be received within said elongate mouth of said flexible clasp member and moved toward the center of the body member until it is disposed substantially through the central bore of said body member. The properties of said flexible clasp member permit said fishing line to be frictionally secured within said flexible clasp member, such that said clasp member (and the attached body member) will remain substantially in one location along the length of said fishing line.

When removal of the fishing float is desired, said fishing line can be easily and quickly removed from said flexible clasp member through the elongate mouth of said flexible clasp member. In this manner, the fishing float of the present invention can be easily and quickly attached to fishing line, or removed from such fishing line, without damaging, impairing or crimping the fishing line in any way.

Said flexible clasp member may be designed with a slit in its middle for line insertion, or molded and then folded over to facilitate line insertion, or with any method which utilizes a soft elastic material to hold fishing line in place as described above, thereby accomplishing the above listed objectives.

By way of illustration, but not limitation, it is to be observed that the buoyant body member of the present invention can be constructed from polymer(s), ABS plastic and/or other material offering the desired characteristics and properties. Further, the flexible clasp member of the present invention can be constructed of polyurethane (such as, for example, polyurethane measuring 30 on a durometer scale) or other material having similar desired characteristics. Notwithstanding the foregoing, other materials having beneficial characteristics may be substituted for such purposes.

In summary, the benefits and features of the fishing float of the present invention that distinguish said fishing float from the prior art include, but are not necessarily limited to: ease and quickness of attachment, removal, and re-attachment of said fishing float to a fishing line, as well as the prevention of any damage or impairment to said line.

### BRIEF DESCRIPTION OF THE DRAWINGS

The foregoing summary, as well as the following detailed description of the preferred embodiments, is better understood when read in conjunction with the appended drawings. For the purpose of illustrating the invention, the drawings show certain preferred embodiments. It is understood, however, that the invention is not limited to the specific methods and devices disclosed. Further, dimensions, materials and part names are provided for illustration purposes only and not limitation.

FIG. 1 depicts a perspective exploded view of the fishing float of the present invention.

FIG. 2 depicts a perspective view of the fishing float of the present invention installed on a fishing line and floating at the surface of a body of water.

FIG. 3 depicts a side view of the fishing float of the present invention.

FIG. 4 depicts an overhead view of the fishing float of the present invention.

FIG. 5 depicts a sectional view of the fishing float of the present invention along line 5-5 of FIG. 3.

FIG. 6 depicts a sectional view of the fishing float of the present invention along line 6-6 of FIG. 4.

### DETAILED DESCRIPTION OF A PREFERRED EMBODIMENT OF THE INVENTION

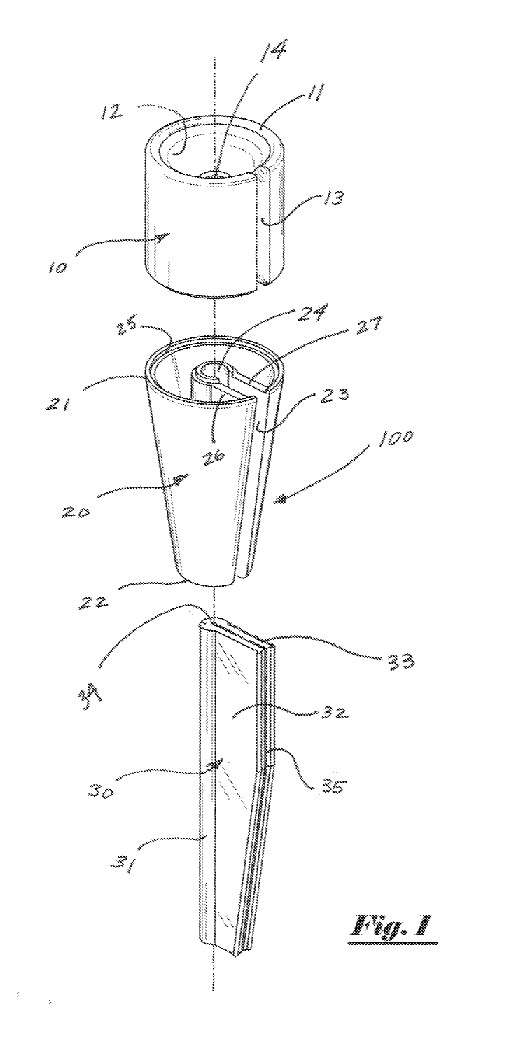

Referring to the drawings, FIG. 1 depicts a perspective exploded view of fishing float 100 of the present invention. In the embodiment depicted in FIG. 1, fishing float 100 of the present invention comprises a buoyant body member comprising substantially hollow upper body member 10 and attached substantially hollow lower body member 20. Although said buoyant body member can have any number of different shapes or configurations to accommodate particular uses and/or environments to be encountered, in the preferred embodiment fishing float 100 has a substantially elongate shape. It is to be observed that fishing float 100 could also have another configuration including, without limitation, a spherical shape, egg-shape, or other beneficial shape.

In the embodiment depicted in FIG. 1, upper body member 10 is substantially hollow and has a substantially cylindrical shape. Upper edge 11 extends around the circumference of the upper portion of body member 10 and forms a rim around bowl-like recess 12. Central bore 14 extends through said upper body member 10, while slot 13 extends through upper body member 10 and extends from the outer surface of said upper body member 10 to central bore 14. In the orientation depicted in FIG. 1, central bore 14 and slot 13 are oriented substantially vertical.

Still referring to FIG. 1, lower body member 20 has a substantially conical shape, said lower body member 20 having a larger diameter near upper end 21 than lower end 22. Although lower body member 20 can be constructed in many different configurations, in the preferred embodiment said lower body member 20 is substantially hollow. Said lower body member 20 further has a central bore 24 extending along the central longitudinal axis of said lower body member 20. A slot 23, formed by opposing substantially parallel wall members 26 and 27, extends along the length of lower body member 20 and opens into central bore 24. Ridge 25 extends around the circumference of upper surface 21, and can be used to frictionally mate upper body member 10 to lower body member 20 using a “snap-fit” arrangement as described in detail below.

Still referring to FIG. 1, flexible clasp member 30 has substantially cylindrical elongate spine member 31. Bore 34 extends axially through said spine member 31, while substantially planar flap members 32 and 33 are in opposing relationship to define a mouth 35 that extends along the length of flexible clasp member 30 and leads to central bore 34. When upper body member 10 and lower body member 20 are joined together, said flexible clasp member 30 can be axially inserted or pulled into aligned bores 24 (of lower body member 20) and 14 (of upper body 10). When installed in this manner, opposing planar flap members 32 and 33 are disposed within aligned slots 23 and 13.

In the preferred embodiment, spine member 31 of flexible clasp member 30 has a diameter slightly larger than the diameter of aligned central bore 24 of lower body member 20 and central bore 14 of upper body member 10. As such, when upper body member 10 and lower body member 20 are attached to one another, spine member 31 can be compressed and received within aligned bores 24 and 14, thereby remaining frictionally stationary and secure within said aligned bores 24 and 14.

Further, in the embodiment depicted in FIG. 1, the widths of flap members 32 and 33 are substantially constant near the upper portions of said flaps and correspond with the substantially uniform radius of upper body member 10, while said widths are tapered near the lower portions of said flaps to correspond to the changing radius of lower body member 20.

FIG. 2 depicts a perspective view of fishing float 100 of the present invention installed on fishing line 200 and floating on water surface 300. As depicted in FIG. 2, upper body member 10 is joined with lower body member 20. Fishing line 200 can be passed through mouth 35 formed by opposing flap members 32 and 33, and received within central bore 34 of spine member 31 of flexible clasp member 30 (which is itself installed within aligned central bores 14 and 24 of upper body member 10 and lower body member 20, respectively). Clasp member 30 is secured within said body members 10 and 20. Fishing line 200 frictionally adheres to flexible clasp member 30 and remains secured within said clasp member 30, such that fishing float 100 will remain substantially in one location along the length of said fishing line 200.

When removal of the fishing float 100 is desired, fishing line 200 can be pulled out of bore 34 of flexible clasp member 30; said fishing line 200 can be pulled through a gap formed between opposing flap members 32 and 33 and, ultimately, out of mouth 35. In this manner, fishing float 100 can be easily and quickly attached to fishing line 200 at a desired location, and removed from said fishing line 200, without damaging, crimping or otherwise impairing said fishing line 200.

It is to be observed, as an alternative method, that a fishing line 200 can be inserted into bore 34 of flexible clasp member 30 before said flexible clasp member 30 is axially inserted or pulled into aligned bores 24 (of lower body member 20) and 14 (of upper body 10). Similarly, if desired, said flexible clasp member 30 can be axially removed from aligned bores 24 (of lower body member 20) and 14 (of upper body 10), and then removed from flexible clasp member 30.

FIG. 3 depicts a side view of fishing float 100 of the present invention. Upper body member 10 has a substantially cylindrical shape, and is attached to lower body member 20. Lower body member 20 has a substantially conical shape, exhibiting a larger diameter near upper end 21 than lower end 22. Flexible clasp member 30 has opposing substantially planar flap members 32 and 33. Said substantially planar flap members 32 and 33 are in opposing relationship, cooperate to form mouth 35, and are received within aligned slots 13 and 23 of said upper and lower body members 10 and 20, respectively.

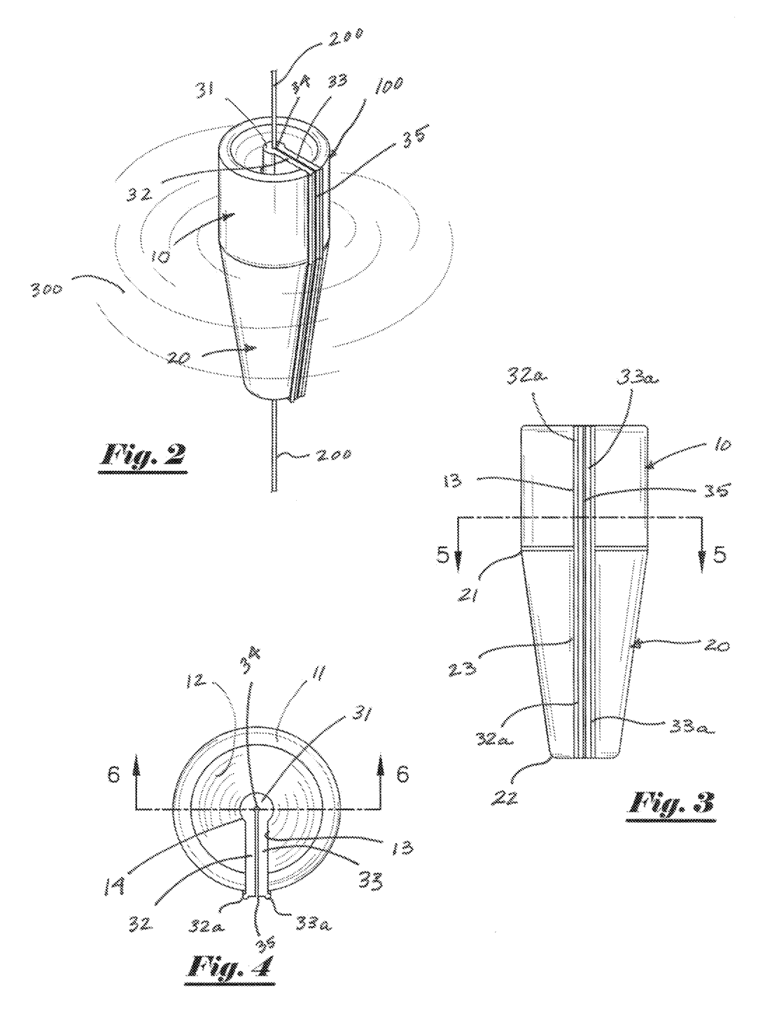

FIG. 4 depicts an overhead view of fishing float 100 of the present invention. Upper body member 10 has a substantially cylindrical shape. Upper edge 11 extends around the circumference of the upper portion of body member 10, as well as bowl-like recess 12. Central bore 14 extends through said upper body member 10, while slot 13 extends through upper body member 10 from the outer surface of said upper body member 10 to central bore 14.

Still referring to FIG. 4, flexible clasp member 30 has substantially cylindrical elongate spine member 31 and bore 34 extending through said spine member 31. Spine member 31 of flexible clasp member 30 is received within bore 14 of upper body member 10. Substantially planar flap members 32 and 33 are in parallel opposing relationship, are disposed within slot 13 of upper body member 10 and cooperate to define a mouth 35 that leads to central bore 34. In the preferred embodiment, substantially planar flap member 32 has outer retention lip 32a, while substantially planar flap member 33 has outer retention lip 33a.

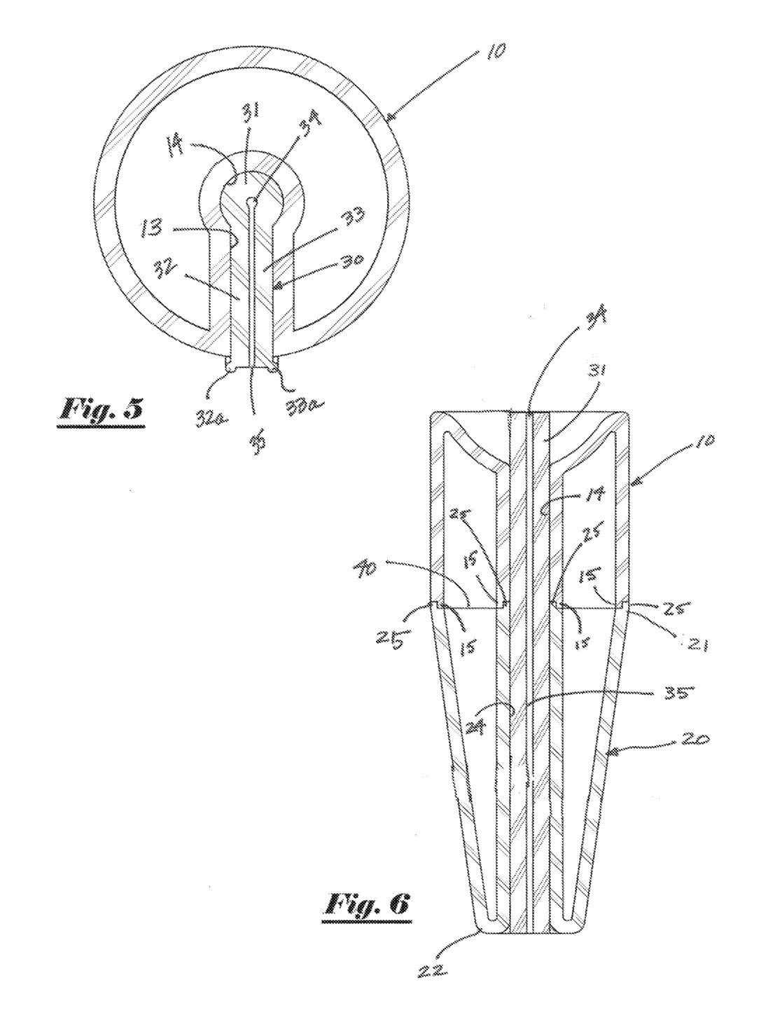

FIG. 5 depicts a sectional view of fishing float 100 of the present invention along line 5-5 of FIG. 3. Upper body member 10 has a substantially cylindrical shape. Central bore 14 extends through said upper body member 10, while slot 13 extends through upper body member 10 from the outer surface of said upper body member 10 to central bore 14. Flexible clasp member 30 has substantially cylindrical elongate spine member 31 and bore 34 extending through said spine member 31. Spine member 31 of flexible clasp member 30 is received within bore 14 of upper body member 10.

Substantially planar flap members 32 and 33 are in parallel opposing relationship, are disposed within slot 13 of upper body member 10 and cooperate to define a mouth 35 that leads to central bore 34. In the preferred embodiment, substantially planar flap member 32 has outer retention lip 32a, while substantially planar flap member 33 has outer retention lip 33a. Said retention lips 32a and 33a extend outwardly beyond the width of slot 13 of upper body member 10, thereby acting to keep said flap members 32 and 33 properly oriented and aligned within slot 13 of upper body member 10. Referring back to FIG. 3, it is to be observed that said retention lips 32a and 33a also extend outwardly beyond the width of slot 23 in lower body member 20, thereby acting to keep said flap members 32 and 33 properly oriented and aligned within slot 23 of lower body member 20.

FIG. 6 depicts a sectional view of fishing float 100 of the present invention along line 6-6 of FIG. 4. Upper body member 10 has a substantially cylindrical shape, and is attached to lower body member 20 along seam 40. In the preferred embodiment, upper body member 10 has ridge 15 that extends around the outer circumference of upper body member 10, as well as bore 14. Similarly, lower body member 20 has ridge 25 that extends around the outer circumference of lower body member 20 near its upper end 21, as well as central bore 24 of lower body member 20. Ridges 15 and 25 are sized to frictionally mate with each other, to permit quick and efficient connection of upper body member 10 to lower body member 20. In the preferred embodiment, upper body member 10 and lower body member 20 can be affixed to one another using glue, cement or other adhesive in order to form a water-tight bond along seam 40

Still referring to FIG. 6, flexible clasp member 30 has substantially cylindrical elongate spine member 31 and bore 34 extending through said spine member 31. Spine member 31 of flexible clasp member 30 is received within aligned bore 14 of upper body member 10 and bore 24 of lower body member 24.

Referring to FIG. 5, in operation, a fishing line (such as fishing line 200 depicted in FIG. 2) can be passed through mouth 35 formed by opposing flap members 32 and 33, and received within flexible clasp member 30. Clasp member 30 is secured within body members 10 (and 20, not shown in FIG. 5) while said fishing line is secured within clasp member 30 by frictionally adhering to said clasp member. In the preferred embodiment, said fishing line should seat within central bore 34 of spine member 31 of flexible clasp member 30; however, it is to be understood that said fishing line may nonetheless remain stationary and frictionally secured within flexible clasp 30 even if said fishing line is not received entirely within central bore 34. As such, fishing float 100 will remain substantially in one location along the length of said fishing line until removal of said fishing float is desired. At that point, said fishing line can be removed from central bore 34 and passed through mouth 35 formed by opposing flap members 32 and 33.

By way of illustration, but not limitation, it is to be observed that joined buoyant body members 10 and 20 of the present invention can be constructed from ABS plastic and/or other material offering similar characteristics. The hollow construction of said body members 10 and 20 allow fishing float 100 of the present invention to float at or near the surface of liquid such as water. Flexible clasp member of the present invention can be constructed of polyurethane (such as, for example, measuring 30 on a durometer scale) or other material having similar characteristics. Notwithstanding the foregoing, other materials may be substituted for such purposes.

In summary, the benefits and features of the fishing float of the present invention that distinguish said fishing float from the prior art include, but are not necessarily limited to: ease and quickness of attachment, removal, and re-attachment of said fishing float to a fishing line, as well as the prevention of any damage or impairment to said line.

The above-described invention has a number of particular features that should preferably be employed in combination, although each is useful separately without departure from the scope of the invention. While the preferred embodiment of the present invention is shown and described herein, it will be understood that the invention may be embodied otherwise than herein specifically illustrated or described, and that certain changes in form and arrangement of parts and the specific manner of practicing the invention may be made within the underlying idea or principles of the invention.

What is claimed:

1. A fishing float comprising:
a. a buoyant body member having an outer surface, a central bore extending through said body member, and a slot extending from said outer surface to said central bore; and
b. a flexible clasp member adapted to frictionally adhere to a fishing line, wherein said flexible clasp member is disposed within said central bore of said body member.

2. The fishing float of claim 1, wherein said flexible clasp member further comprises a plurality of substantially planar flaps disposed within said slot.

3. The fishing float of claim 1, wherein said body member has a top, a bottom and a substantially cylindrical shape.

4. The fishing float of claim 3, wherein the diameter of said body member is smaller at said bottom than at said top.
